(19) United States
(12) Patent Application Publication
(10) Pub. No.: US 2021/0164605 A1
(43) Pub. Date: Jun. 3, 2021

(54) FIXATION STRUCTURE AND GIMBAL SYSTEM

(71) Applicant: SZ DJI TECHNOLOGY CO., LTD., Shenzhen (CN)

(72) Inventors: Naixu YANG, Shenzhen (CN); Xiaoyu TIAN, Shenzhen (CN); Guoyao LIU, Shenzhen (CN)

(21) Appl. No.: 17/173,120

(22) Filed: Feb. 10, 2021

Related U.S. Application Data
(63) Continuation of application No. PCT/CN2018/101396, filed on Aug. 20, 2018.

(51) Int. Cl. F16M 11/24; F16M 11/20; F16M 11/04

(52) U.S. Cl. CPC F16M 11/24; G03B 17/561; F16M 11/045; F16M 11/2014

(57) ABSTRACT

A fixation structure includes a hot shoe plate, a hot shoe rod assembly, a locking assembly, and a fixation assembly. The hot shoe plate includes a connection member and a sliding member. The connection member is arranged at a first end of the hot shoe plate. The sliding member is arranged at a second end of the hot shoe plate that is opposite to the first end. The hot shoe rod assembly includes a fixation rod detachably mounted at the connection member. The fixation rod includes a top member and a bottom member opposite to each other. The bottom member is configured to be connected to a gimbal. The locking assembly is configured to fix the hot shoe rod assembly at the hot shoe plate. The fixation assembly is configured to cooperate with the sliding member to connect a load at any position of the sliding member.

### CROSS-REFERENCE TO RELATED APPLICATION

This application is a continuation of International Application No. PCT/CN2018/101396, filed Aug. 20, 2018, the entire content of which is incorporated herein by reference.

### TECHNICAL FIELD

The present disclosure generally relates to the photographing technology field and, more particularly, to a fixation structure and a gimbal system.

### BACKGROUND

When a camera is used to photograph, to ensure the stability of a captured picture, a gimbal is usually adopted to increase the stability of the camera. However, when the camera is carried at the gimbal, since the camera is too high and too heavy, the camera is not easy to be steadily carried at the gimbal.

### SUMMARY

Embodiments of the present disclosure provide a fixation structure including a hot shoe plate, a hot shoe rod assembly, a locking assembly, and a fixation assembly. The hot shoe plate includes a connection member and a sliding member. The connection member is arranged at a first end of the hot shoe plate. The sliding member is arranged at a second end of the hot shoe plate that is opposite to the first end. The hot shoe rod assembly includes a fixation rod detachably mounted at the connection member. The fixation rod includes a top member and a bottom member opposite to each other. The bottom member is configured to be connected to a gimbal. The locking assembly is configured to fix the hot shoe rod assembly at the hot shoe plate. The fixation assembly is configured to cooperate with the sliding member to connect a load at any position of the sliding member.

Embodiments of the present disclosure provide a gimbal system including a gimbal, a load, and a fixation structure. The fixation structure is configured to be connected to the load at the gimbal. The fixation structure includes a hot shoe plate, a hot shoe rod assembly, a locking assembly, and a fixation assembly. The hot shoe plate includes a connection member and a sliding member. The connection member is arranged at a first end of the hot shoe plate. The sliding member is arranged at a second end of the hot shoe plate that is opposite to the first end. The hot shoe rod assembly includes a fixation rod detachably mounted at the connection member. The fixation rod includes a top member and a bottom member opposite to each other. The bottom member is configured to be connected to a gimbal. The locking assembly is configured to fix the hot shoe rod assembly at the hot shoe plate. The fixation assembly is configured to cooperate with the sliding member to connect a load at any position of the sliding member.

### BRIEF DESCRIPTION OF THE DRAWINGS

FIG. 1 is a schematic perspective assembly diagram of a fixation structure according to some embodiments of the present disclosure.

FIG. 2 is a schematic perspective exploded diagram of the fixation structure according to some embodiments of the present disclosure.

FIG. 3 is a schematic enlarged view of part III in FIG. 2.

FIG. 4 is a schematic enlarged view of part IV in FIG. 2.

FIG. 5 is a schematic perspective assembly diagram of the fixation structure from another view angle according to some embodiments of the present disclosure.

FIG. 6 is a schematic cross-sectional structural diagram of the fixation structure along line VI-VI in FIG. 1.

FIG. 7 is a schematic cross-sectional structural diagram of the fixation structure along line VII-VII in FIG. 1.

FIG. 8 is a schematic cross-sectional structural diagram of the fixation structure along line VIII-VIII in FIG. 1.

Reference numerals:

| | | | | | |
|---|---|---|---|---|---|
| 10 | Fixation structure | 11 | Hot shoe plate | 11a | First end |
| 111 | Connection member | 1111 | Through-hole | 11111 | Accommodation section |
| 11112 | Connection section | 11113 | Through section | 1112 | First locking member |
| 1113 | Second locking member | | | 11b | Second End |
| 112 | Sliding member | 1121 | Sliding slot | 113 | Upper surface |
| 114 | Lower surface | 115 | Side surface | 1151 | Locking hole |
| 11511 | First sub locking hole | | | 11512 | Second sub locking hole |
| 116 | Cold shoe groove | 1161 | Upper part | 1162 | Lower part |
| 1163 | Connection opening | 117 | Connection opening | 118 | Position limiting member |
| 12 | Hot shoe rod assembly | | | 121 | Knob cover |
| 1211 | Cover body | 1212 | Connection rod | 122 | Fixation rod |
| 1221 | Top member | 12211 | Opening | 1222 | Bottom member |
| 12221 | Connection hole | 123 | Extension rod | 1231 | Connection end |
| 1232 | Opening end | 13 | Locking assembly | 131 | Locking part |
| 1311 | Locking end | 1312 | Knob end | 1313 | Abutting member |
| 132 | Locking knob | 1321 | Step through-hole | 133 | Locking gasket |
| 134 | Locking screw | | | 135 | Locking elastic member |
| 14 | Connection assembly | 15 | Fixation assembly | 151 | Adjustment knob |
| 1511 | Top surface | 1512 | Bottom surface | 1513 | Side surface |
| 1514 | Side hole | | | 152 | Adjustment threaded rod |
| 1521 | Rod body | 1522 | Blocking member | 153 | Upper fixation block |
| 1531 | Upper recess | 15311 | Bottom wall | 1532 | Sidewall |
| 15321 | Connection opening | 154 | Lower fixation block | 1541 | Body |
| 15411 | First surface | 15412 | Second surface | 15413 | Accommodation groove |
| 1542 | Protrusion | 1543 | Lower recess | 15431 | Bottom wall |
| 155 | Fixation gasket | 156 | Fastening member | 157 | Fixation elastic member |

### DETAILED DESCRIPTION OF THE EMBODIMENTS

Embodiments of the present disclosure are described in detail. Examples of embodiments are shown in the accompanying drawings. A same or similar character may be used to represent a same or similar element or elements having a same or similar function. Embodiments described with reference to the accompanying drawings are exemplary and only used to explain the present disclosure and should not be understood as a limitation of the present disclosure.

In the description of embodiments of the present disclosure, orientation or position relationship indicated by terms “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” “counterclockwise” is based on the orientation or position relationship shown in the drawings, only to facilitate the description of embodiments of the present disclosure and simplify the description, rather than indicating or implying that the device or element referred to must have a specific orientation and be constructed and operated in a specific orientation. Therefore, the terms should not be understood to limit embodiments of the present disclosure. In addition, the terms “first” and “second” are used for descriptive purposes only, and should not be understood to indicate or imply relative importance or implicitly indicating the number of indicated technical features. Thus, a feature associated with “first” and “second” may explicitly or implicitly include one or more of such feature. In the description of embodiments of the present disclosure, the meaning of “plurality” is two or more, unless otherwise specified.

In the description of embodiments of the present disclosure, the terms “mount,” “connection,” and “coupling” should be understood in a broad sense. For example, the terms may indicate a fixed connection, a detachable connection, an integral connection, a mechanical connection, an electrical connection, a communication, a direct connection, an indirect connection through an intermediary, internal communication of two components, or interaction relationship of two components. Those of ordinary skill in the art should understand the specific meanings of the above terms in embodiments of the present disclosure according to specific situations.

In embodiments of the present disclosure, unless otherwise specified and defined, the first feature “above” or “below” the second feature may include the direct contact of the first and second features or may include indirect contact of the first and second features through other medium therebetween. Moreover, the first feature being “above,” “on,” and “over” the second feature includes that the first feature is directly above or obliquely above the second feature, or simply means that the first feature is higher in level than the second feature. The first feature being “below,” “under,” and “beneath” the second feature includes that the first feature is directly under or obliquely under the second feature, or simply means that the first feature is lower in height than the second feature.

The present disclosure provides many various embodiments or examples to implement different structures of embodiments of the present disclosure. For simplicity, components and settings of specific examples are described below. The description is merely exemplary and does not intend to limit embodiments of the present disclosure. Reference numerals and/or letters are repeated in different examples in embodiments of the present disclosure for simplicity and clarity and do not indicate a relationship among various implementations and/or settings. Embodiments of the present disclosure provide examples of various specific processes and materials, but those of ordinary skill in the art may be aware of an application of other processes and/or use of other materials.

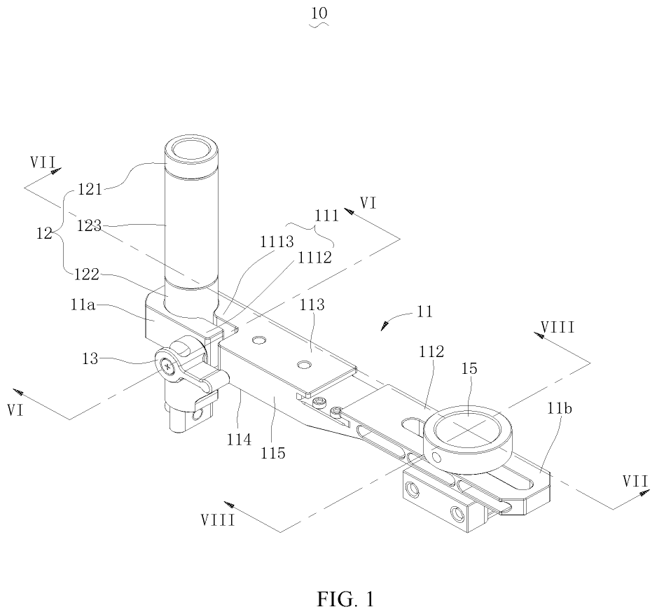

As shown in FIG. 1, a fixation structure 10 consistent with embodiments of the present disclosure is configured to connect a load to a gimbal. The fixation structure 10 includes a hot shoe plate 11, a hot shoe rod assembly 12, a locking assembly 13, and a fixation assembly 15. The hot shoe plate 11 includes a first end 11a and a second end 11b opposite to each other. A connection member 111 is arranged at the first end 11a, and a sliding member 112 is arranged at the second end 11b. The hot shoe rod assembly 12 includes a fixation rod 122 detachably arranged at the connection member 111. The hot shoe rod assembly 12 may cause the hot shoe plate 11 to be fixed at different positions of the hot shoe rod assembly 12 by the detachable connection of the connection member 111. The fixation rod 122 includes a top member 1221 and a bottom member 1222 opposite to each other. The bottom member 1222 may be configured to be connected to the gimbal. The locking assembly 13 may be configured to fix the hot shoe rod assembly 12 at the hot shoe plate 11. The fixation assembly 15 may be configured to cooperate with the sliding member 112 to connect the load at any position of the sliding member 112.

In some embodiments, the load may include a device for acquiring external information and news, such as a camera, a cell phone, a tablet, a sensor, etc. The gimbal may include a three-axis gimbal, a two-axis gimbal, or a single axis gimbal. When the load is connected to the gimbal, the gimbal may stabilize the load and change the orientation and angle of the load. In some embodiments, an example may be described by using a camera (including a single-lens reflex (SLR) camera, a video recorder, a card camera, a surveillance camera, or another electronic device with a photographing function) as the load and the three-axis gimbal.

During a process of mounting the fixation rod 122 at the connection member 111, the fixation rod 122 may move along a direction perpendicular to a direction between the first end 11a and the second end 11b, that is, along a first direction, until the fixation rod 122 has a suitable position relative to the connection member 111. For example, the connection member 111 may be located at a position at half, one third, or one fourth of the length of the fixation rod 122. Then, the hot shoe rod assembly 12 may be fixed at the hot shoe plate 11 by the locking assembly 13.

During a process of connecting the load at the sliding member 112, the fixation assembly 15 may slide with the load along a direction between the first end 11a and the second end 11b, that is, along a second direction, until the fixation assembly 15 and the load may have a suitable position relative to the sliding member 112. For example, the fixation assembly 15 and the load may be located at a half, one third, or one fourth of the length of the sliding member 112 along an extension direction. Then, the load may be fixed at the sliding member 112 by the fixation assembly 15. The first direction may be perpendicular to the second direction.

In some embodiments, the fixation structure 10 may be connected to the gimbal by the hot shoe rod assembly 12 and to the load by the cooperation of the fixation assembly 15 and the sliding member 112 to cause the load to be firmly carried at the gimbal. When the load cannot be firmly carried at the gimbal, the fixation structure 10 may help to fix the load. In addition, since the fixation rod 122 may move along the first direction relative to the hot shoe plate 11, the load may move along the second direction relative to the hot shoe plate 11, and the gimbal may be connected to the bottom member 1222 of the fixation rod 122, the load may move along the first direction, the second direction, or the first direction and the second direction relative to the gimbal to move the load to a suitable position of a center of gravity to be carried stably.

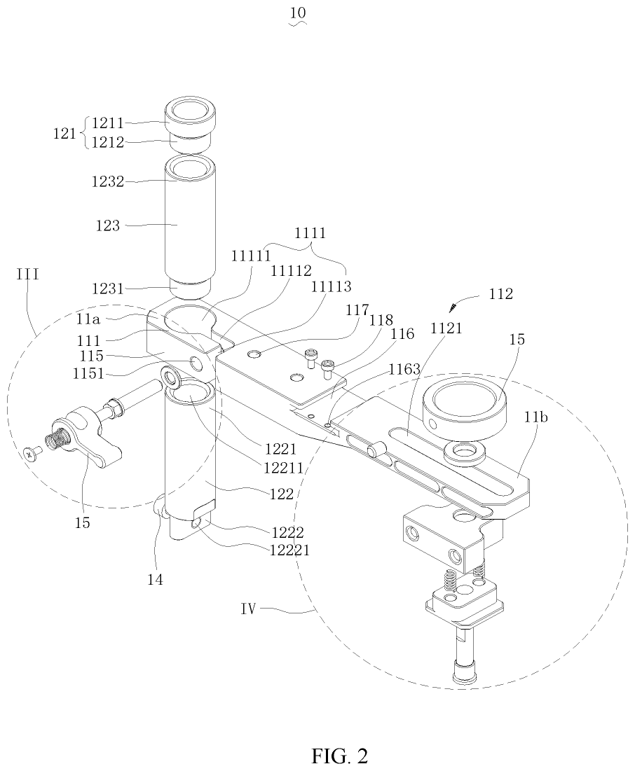

As shown in FIG. 1 and FIG. 2, the fixation structure 10 consistent with embodiments of the present disclosure includes the hot shoe plate 11, the hot shoe rod assembly 12, the locking assembly 13, a connection assembly 14, and the fixation assembly 15.

The shape of the hot shoe plate 11 may include a long strip. The hot shoe plate 11 includes the first end 11a and the second end 11b opposite to each other. That is, two ends of the long strip include the first end 11a and the second end 11b, respectively. The connection member 111 is arranged at the first end 11a. The sliding member 112 is arranged at the second end 11b. The connection member 111 includes a through-hole 1111 or a blind hole. The sliding member 112 includes a sliding slot 1121.

The hot shoe plate 11 includes an upper surface 113, a lower surface 114, and a side surface 115. The upper surface 113 and the lower surface 114 are located at two sides of the hot shoe plate 11 opposite to each other. When the connection member 111 includes the through-hole 1111, the through-hole 1111 extends from the upper surface 113 to the lower surface 114. When the connection member 111 includes the blind hole, the blind hole may only penetrate the upper surface 113 or the lower surface 114. A direction of a central axis of the through-hole 1111 or the blind hole is perpendicular to the upper surface 113 and the lower surface 114. The sliding slot 1121 extends from the upper surface 113 to the lower surface 114. An extension direction of the sliding slot 1121 includes the direction between the first end 11a and the second end 11b. That is, the extension direction of the sliding slot 1121 includes the second direction. When the load is a camera, the extension direction of the sliding slot 1121 may be perpendicular to an optical axis of the camera.

A cold shoe groove 116 is arranged at the upper surface 113. The cold shoe groove 116 may be configured to be connected to another device, such as a device with a male cold shoe of a microphone, a compensation light, etc. The cold shoe groove 116 is located between the first end 11a and the second end 11b. One or a plurality of cold shoe grooves 116 may be included. When one cold shoe groove 116 is included, the cold shoe groove 116 is located at a center area between the first end 11a and the second end 11b. When the plurality of (e.g., two, three, or four) cold shoe grooves 116 are included, the plurality of cold shoe grooves 116 may be distributed between the first end 11a and the second end 11b at an even interval. Since the cold shoe groove 116 is located in the center area between the first end 11a and the second end 11b, or the plurality of cold shoe grooves 116 may be distributed between the first end 11a and the second end 11b at the even interval, an even force may be ensured for the hot shoe plate 11 when another device is connected to the cold shoe groove 116. The cold shoe groove 116 includes an upper part 1161 and a lower part 1162 that are connected. An opening of the upper part 1161 may be smaller than an opening of the lower part 1162. The cold shoe groove 116 may include a stepped groove formed by recessing the upper surface 113 toward the lower surface 114. In some other embodiments, the cold shoe groove 116 may include a stepped groove formed by protruding from the upper surface 113 toward a direction away from the lower surface 114.

At least one connection opening 117 is arranged at the upper surface 113, for example, one, two, three, or four connection openings 117 may be arranged at the upper surface 113. The connection opening 117 of the upper surface 113 is located between the connection member 111 and the cold shoe groove 116, and/or between the cold shoe groove 116 and the sliding slot 112. At least one connection opening 1163 is arranged on a bottom wall 15311 of the cold shoe groove 116, for example, one, two, three, or four connection openings 1163 may be arranged on the bottom wall 15311 of the cold shoe groove 116. The connection opening 117 of the upper surface 113 and the connection opening 1163 of the bottom wall 15311 of the cold shoe groove 116 may be configured to be connected to another device mechanically. Since the cold shoe groove 116 and the connection opening 117 are arranged at the upper surface 113, and the connection opening 1163 is arranged on the bottom wall 15311 of the cold shoe groove 116, the fixation structure 10 may provide a variety of extension interfaces to connect to another device needed during the operation of the load and reduce the workload of the interface of the load. The appearance structure may be simple. The hot shoe plate 11 further includes at least one position limiting member 118, for example, a position limiting screw. The position limiting member 118 may be fixed at the upper surface 113 via a thread and provide a position limiting effect for other devices when needed.

The side surface 115 connects the upper surface 113 and the lower surface 114. A locking hole 1151 is arranged at the side surface 115.

The hot shoe rod assembly 12 includes a knob cover 121 and a fixation rod 122.

The knob cover 121 includes a cover body 1211 and a connection rod 1212 extending from the cover body 1211. An outer thread is arranged at the connection rod 1212. The fixation rod 122 is detachably mounted to the connection member 111. The fixation rod 122 includes a top member 1221 and a bottom member 1222 opposite to each other. The bottom member 1222 may be configured to be connected to the gimbal. The fixation rod 122 may include a hollow structure with the bottom member 1222 closed and an opening 12211 arranged at the top member 1221 to cause the weight of the hot shoe rod assembly 12 to be relatively light.

In some embodiments, the knob cover 121 is connected to the top member 1221 and shields the opening 12211. An inner thread is arranged at the top member 1221. The connection rod 1212 is inserted in the fixation rod 122. The outer thread of the connection rod 1212 cooperates with the inner thread of the top member 1221 to connect the knob cover 121 and the fixation rod 122. The outer thread of the connection rod 1212 and the inner thread of the top member 1221 are not exposed. The cover body 1211 shields the opening 12211 to prevent dust, water, or other material from entering the fixation rod 122 from the opening 12211.

In some other embodiments, the hot shoe rod assembly 12 further includes an extension rod 123. The extension rod 123 may be configured to provide an extension function when the length of the fixation rod 122 cannot meet the requirement. The extension rod 123 includes a connection end 1231 and an opening end 1232 opposite to each other. The connection end 1231 is connected to the top member 1221 and shields the opening 12211. The knob cover 121 is connected to the opening end 1232 and shields the opening end 1232. The inner thread is arranged at the top member 1221. The outer thread is arranged at the connection end 1231. The outer thread of the connection end 1231 and the inner thread of the top member 1221 may cooperate to connect the extension rod 123 and the fixation rod 122. The outer thread of the connection end 1231 and the inner thread of the top member 1221 are not exposed. An inner thread is arranged at the opening end 1232. The connection rod 1212 is inserted in the fixation rod 122. The outer thread of the connection rod 1212 and the inner thread of the opening end 1232 may cooperate to connect the knob cover 121 and the extension rod 123. The outer thread of the connection rod 1212 and the inner thread of the opening end 1232 are not exposed. The knob cover 1211 shields the opening end 1232 to prevent dust, water, or another substance from entering the extension rod 123 through the opening end 1232.

The fixation rod 122 and the extension rod 123 may be formed of an aluminum alloy material. The aluminum alloy material may have a small density and high strength, may be beneficial to ensure the strength and safety of the connection of the load and the gimbal, and may not increase the weight excessively.

When the hot shoe rod assembly 12 includes the knob cover 121 and the fixation rod 122, or the knob cover 121, the fixation rod 122, and the extension rod 123, a connection hole 12221 is arranged at the bottom member 1222 of the fixation rod 122 to connect an arm of the gimbal. When the load includes a camera, the central axis of the connection hole 12221 may be perpendicular to the optical axis of the camera.

In some other embodiments, a relative position relationship of the fixation rod 122 and the extension rod 123 may be exchanged along the first direction, or the hot shoe rod assembly 12 may include one fixation rod 122 and a plurality of extension rods 123, or a plurality of fixation rods 122 and one extension rod 123, or the plurality of fixation rods 122 and the plurality of extension rods 123.

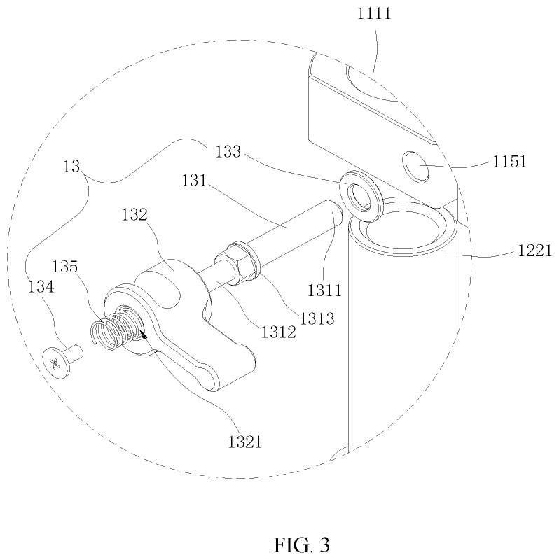

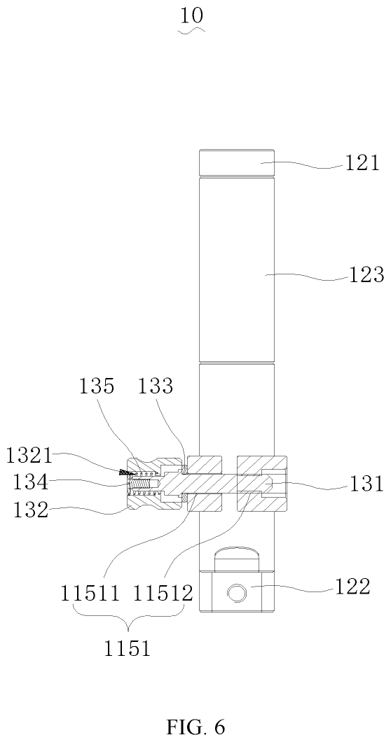

As shown in FIG. 2, FIG. 3, and FIG. 6, the locking assembly 13 is configured to fix the hot shoe rod assembly 12 at the hot shoe plate 11. The locking assembly 13 includes a locking part 131, a locking knob 132, a locking gasket 133, a locking screw 134, and a locking elastic member 135.

The locking part 131 passes through and is locked in the locking hole 1151 to fix the hot shoe rod assembly 12 at the hot shoe plate 11. In some embodiments, the locking part 131 may be a locking threaded rod, including a locking end 1311 passing through the locking hole 1151 and a knob end 1312 opposite to the locking end 1311. The locking knob 132 is fixed at the knob end 1312 opposite to the side surface 115. The locking part 131 further includes an abutting member 1313 located at the knob end 1312. A stepped through-hole 1321 is arranged at the locking knob 132. The abutting member 1313 is inserted in the stepped through-hole 1321 from a side of the locking knob 132. The locking screw 134 is inserted in the stepped through-hole 1321 from another side of the locking knob 132 to be screwed with the locking part 131. The locking elastic member 135 is accommodated in the stepped through-hole 1321 and sleeved at the locking part 131. An end of the locking elastic member 135 is coupled to the step of the stepped through-hole 1321, and another end of the locking elastic member 135 is coupled to the locking screw 134. The locking elastic member 135 may include a spring. The locking gasket 133 is sleeved at the locking part 131 and located between the abutting member 1313 and the side surface 115. The locking gasket 133 may include a ring-shaped gasket. The locking gasket 133 may include a wear-resistant material, for example, polyoxymethylene (POM), high carbon steel, cast iron, diamond, etc.

In some embodiments, the locking hole 1151 corresponds to and communicates with the through-hole 1111. The locking part 131 passes through the locking hole 1151 to be connected to the fixation rod 122.

In some other embodiments, the connection member 111 includes a first locking member 1112 and a second locking member 1113 arranged at an interval. The fixation rod 122 is inserted in the through-hole 1111 and is clamped by the first locking member 1112 and the second locking member 1113. A distance between the first locking member 1112 and the second locking member 1113 may be adjusted to change a clamping force applied to the fixation rod 122. The through-hole 1111 includes an accommodation section 11111, a connection section 11112, and a through section 11113. The fixation rod 122 passes through and is arranged in the accommodation section 11111. The connection section 11112 connects the accommodation section 11111 and the through section 11113. The through section 11113 passes through the side surface 115. The through-hole 1111 divides the connection member 111 into the first locking member 1112 and the second locking member 1113. The locking hole 1151 corresponds to the connection section 11112 and includes a first sub locking hole 11511 and a second sub locking hole 11512. The first sub locking hole 11511 passes through the first locking member 1112. The second sub locking hole 11512 is arranged at the second locking member 1113 and is aligned with the first sub locking hole 11511. The locking part 131 passes through the first sub locking hole 11511 and the connection section 11112 and is locked in the second sub locking hole 11512.

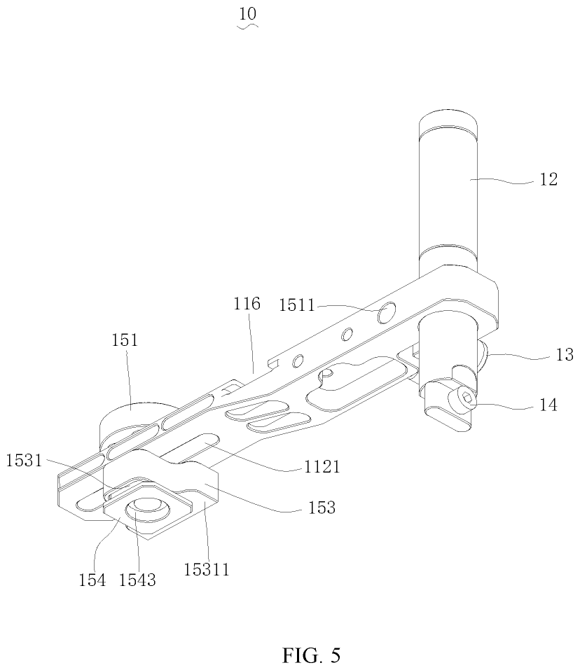

In connection with FIG. 5, the connection assembly 14 cooperates with the connection hole 12221 and is configured to be connected to the arm of the gimbal. in some embodiments, the connection assembly 14 passes through the connection hole and the opening of a pitch axis of the gimbal in sequence to cause the hot shoe rod assembly 12 to be connected to the gimbal.

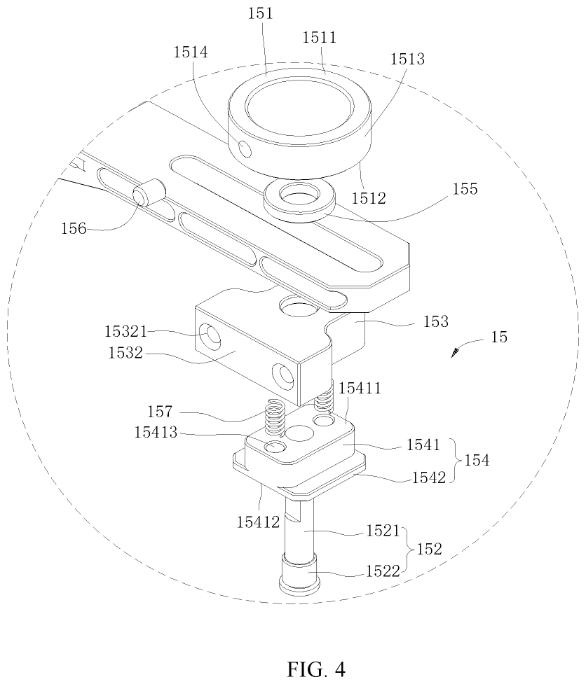

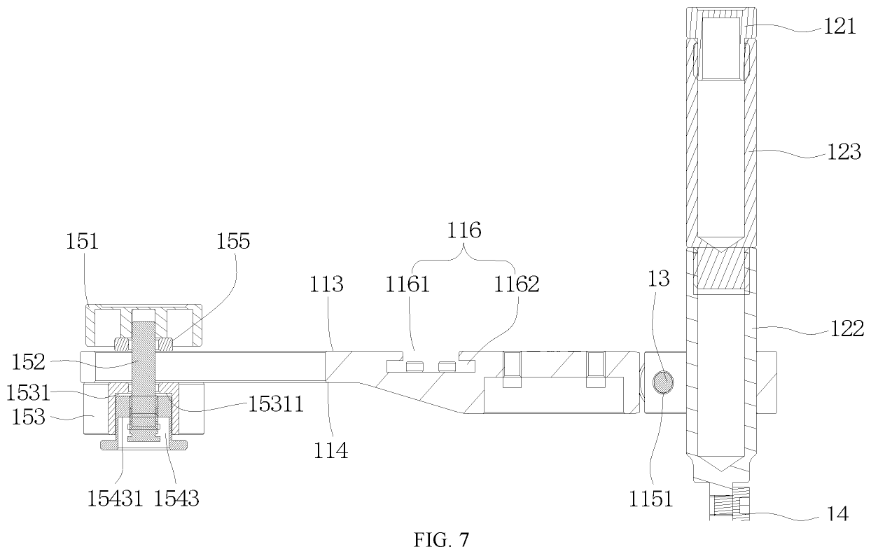

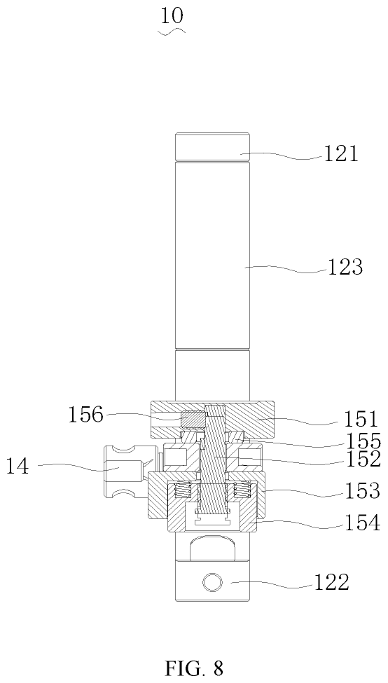

As shown in FIG. 2, FIG. 4, FIG. 7, and FIG. 8, the fixation assembly 15 cooperates with the sliding member 112 to connect the load to any position of the sliding member 112. The fixation assembly 15 includes an adjustment knob 151, an adjustment threaded rod 152, an upper fixation block 153, a lower fixation block 154, a fixation gasket 155, a fastening member 156, and a fixation elastic member 157.

The adjustment knob 151 is arranged at the upper surface 113. The adjustment knob 151 includes a top surface 1511, a bottom surface 1512, and a side surface 1513 connecting the top surface 1511 and the bottom surface 1512. The bottom surface 1512 faces the upper surface 113. A groove is arranged at the bottom surface 1512. A side hole 1514 communicating with the groove is arranged at the side surface 1513.

The adjustment threaded rod 152 is fixedly connected to the adjustment knob 151. The adjustment threaded rod 152 passes through the sliding slot 1121. The adjustment threaded rod 152 includes a rod body 1521 and a blocking member 1522. The blocking member 1522 is located at an end of the rod body 1521 away from the adjustment knob 151. An end of the rod body 1521 away from the blocking member 1522 is accommodated in the groove. The fastening member 156 passes through the side hole 1514 and is fixedly connected to the rod body 1521. In some embodiments, the fastening member 156 may abut directly a portion of the rod body 1521 inserted in the groove to cause the adjustment threaded rod 152 to be fixedly connected to the adjustment knob 151. In some other embodiments, an inner thread may be arranged at the portion of the rod body 1521 inserted in the groove, and an external thread may be arranged at the fastening member 156. The outer thread of the fastening member 156 and the inner thread of the rod body 1521 may cooperate to cause the adjustment threaded rod 152 to be fixedly connected to the adjustment knob 151.

The upper fixation block 153 is arranged on a side where the lower surface 114 is located. The adjustment threaded rod 152 passes through the upper fixation block 153. An upper recess 1531 is arranged at the upper fixation block 153. At least one connection opening 15321 is arranged on a sidewall 1532 of the upper fixation block 153, for example, one, two, three, or four connection openings 15321. The connection opening 15321 is configured to mechanically connect another device, for example, a fixation rod of a follow focus motor. Since at least one connection opening 15321 is arranged on the sidewall 1532 of the upper fixation block 153, the fixation structure 10 may provide a variety of extension interfaces to connect the another device needed during the operation of the load and reduce the workload of the interface of the load.

The lower fixation block 154 is arranged on the side where the lower surface 114 is located. The lower fixation block 154 passes through the upper fixation block 153. The adjustment threaded rod 152 passes through the upper fixation block 153 to be screwed with the lower fixation block 154. The blocking member 1522 blocks the lower fixation block 154. In some embodiments, the lower fixation block 154 includes a body 1541 and a protrusion 1542, which extends from both sides of the body 1541. The protrusion 1542 cooperates with the hot shoe groove of the load to fix the load. The body 1541 is accommodated in the upper recess 1531. The body 1541 includes a first surface 15411 and a second surface 15412 opposite to each other. The first surface 15411 is located in the upper recess 1531. The first surface 15411 is recessed toward the second surface 15412 to form an accommodation groove 15413. The second surface 15412 is recessed toward the first surface 15412 to form a lower recess 1543. The blocking member 1522 abuts the bottom wall 15311 of the lower recess 1543.

The fixation gasket 155 is sleeved at the adjustment threaded rod 152 and is clamped between the adjustment knob 151 and the upper surface 113. The fixation gasket 155 may include a ring-shaped gasket. The fixation gasket 155 may include a wear-resistant material, for example, POM, high carbon steel, cast iron, diamond, etc.

An end of the fixation elastic member 157 is coupled to the upper fixation block 153. Another end of the fixation elastic member 157 is coupled to the lower fixation block 154. In some embodiments, the fixation elastic member 157 is accommodated n the accommodation groove 15413. An end of the fixation elastic member 157 is coupled to the bottom wall 15311 of the upper recess 1531. Another end of the fixation elastic member 157 is coupled to the bottom wall of the accommodation groove 15413. The fixation elastic member 157 may include a spring, which is configured to provide a pre-tension between the lower fixation block 154 and the upper fixation block 153. A plurality of fixation elastic members 157 may be included. The plurality of fixation elastic members 157 may be distributed evenly around the adjustment threaded rod 152. For example, two fixation elastic members 157 may be included. Then, two accommodation grooves 15413 may be included. The two fixation elastic members 157 may evenly provide a pre-tension between the lower fixation block 154 and the upper fixation block 153.

During mounting, the adjustment threaded rod 152 is fixedly connected to the adjustment knob 151 by the fastening member 156. The adjustment knob 151 may rotate to drive the adjustment threaded rod 152 to rotate. The adjustment threaded rod 152 may rotate to cause the lower fixation block 154 to move along the rod body 1521 with the limitation of the upper fixation block 153. For example, when the adjustment threaded rod 152 is rotated clockwise, the lower fixation block 154 may move downward along the rod body 1521. When the adjustment threaded rod 152 is rotated counterclockwise, the lower fixation block 154 may move upward along the rod body 1521. As such, the hot shoe grooves of different loads may be connected by adjusting the position of the lower fixation block 154 at the rod body 1521.

In some other embodiments, a blocking member 1522 may not be arranged at the adjustment threaded rod 152. The adjustment knob 151 and the adjustment threaded rod 152 may be an integral structure. The lower fixation block 154 may be coupled to the hot shoe groove of the load first. Then, the adjustment knob 151 may be rotated to tightly rotate the adjustment threaded rod 152 and the lower fixation block 154.

Embodiments of the present disclosure further provide a gimbal system. The gimbal system includes a gimbal, a load, and the fixation structure 10. The fixation structure 10 may be configured to connect the load to the gimbal.

The gimbal system consistent with embodiments of the present disclosure may be connected to the gimbal through the hot shoe rod assembly 12. The fixation assembly 15 and the sliding member 112 may cooperate to connect the load to cause the load to be stably carried by the gimbal.

In the description of this specification, referring to the terms “certain embodiments,” “one embodiment,” “some embodiments,” “exemplary embodiments,” “examples,” “specific examples,” or “some examples,” the description means that specific features, structures, materials, or characteristics described in connection with embodiments or examples are included in at least one embodiment or example of the present disclosure. In this specification, the schematic description of the above terms does not necessarily refer to a same embodiment or example. The described specific features, structures, materials, or characteristics may be combined in any suitable manner in any one or more embodiments or examples.

Although embodiments of the present disclosure have been shown and described above, embodiments are exemplary and should not be understood as limiting the present disclosure. Those of ordinary skill in the art may perform modifications, changes, replacements, and variations on embodiments within the scope of the present disclosure. The scope of the present invention is defined by the claims and their equivalents.

What is claimed is:

1. A fixation structure comprising:
a hot shoe plate including:
a connection member arranged at a first end of the hot shoe plate; and
a sliding member arranged at a second end of the hot shoe plate that is opposite to the first end;
a hot shoe rod assembly including a fixation rod detachably mounted at the connection member, the fixation rod including a top member and a bottom member opposite to each other, and the bottom member being configured to be connected to a gimbal;
a locking assembly configured to fix the hot shoe rod assembly at the hot shoe plate; and
a fixation assembly configured to cooperate with the sliding member to connect a load at any position of the sliding member.

2. The fixation structure of claim 1, wherein:
the fixation rod includes a hollow structure with the bottom member closed and the top member including an opening; and
the hot shoe rod assembly further includes a knob cover connected to the top member and configured to shield the opening.

3. The fixation structure of claim 2, wherein:
an inner thread is arranged at the top member; and
the knob cover includes:
a cover body configured to shield the opening; and
a connection rod extending from the cover body and inserted in the fixation rod, the connection rod including an outer thread configured to cooperate with the inner thread of the top member.

4. The fixation structure of claim 1, wherein:
the fixation rod includes a hollow structure with the bottom member closed and the top member including an opening; and
the hot shoe rod assembly further includes:
an extension rod including a connection end and an opening end opposite to each other, the connection end being connected to the top member and configured to shield the opening; and
a knob cover connected to the opening end and configured to shield the opening end.

5. The fixation structure of claim 4, wherein:
the top member includes a first inner thread;
the connection end includes a first outer thread configured to cooperate with the first inner thread;
the opening end includes a second inner thread; and
the knob cover includes:
a cover body configured to shield the opening end; and
a connection rod extending from the cover body and inserted in the fixation rod, the connection rod including a second outer thread of the connection rod configured to cooperate with the second inner thread.

6. The fixation structure of claim 1, wherein:
the hot shoe plate includes:
an upper surface and a lower surface located at two sides of the hot shoe plate opposite to each other, the connection member including a through-hole extending from the upper surface to the lower surface; and
a side surface connecting the upper surface and the lower surface, and including a locking hole; and
the locking assembly includes:
a locking part passing through and being locked in the locking hole to fix the hot shoe rod assembly at the hot shoe plate.

7. The fixation structure of claim 6, wherein:
the locking part is a locking threaded rod including a locking end passing through the locking hole and a knob end opposite to the locking end; and
the locking assembly further includes a locking knob fixed at the knob end opposite to the side surface.

8. The fixation structure of claim 7, wherein:
the locking part further includes an abutting member located at the knob end and inserted in a stepped through-hole of the locking knob from a side of the locking knob; and
the locking assembly further includes:
a locking screw inserted in the stepped through-hole from another side of the locking knob and screwed with the locking part; and
a locking elastic member accommodated in the stepped through-hole and sleeved at the locking part, an end of the locking elastic member being coupled to a step of the stepped through-hole, and another end of the locking elastic member being coupled to the locking screw.

9. The fixation structure of claim 7, wherein:
the locking hole corresponds to and communicates with the stepped through-hole, and the locking part passes through the locking hole to be connected to the fixation rod; or
the connection member includes a first locking member and a second locking member spaced apart from each other, the fixation rod passing through the stepped through-hole and being clamped by the first locking member and the second locking member, and an interval between the first locking member and the second locking member being adjustable to change a clamping force applied to the fixation rod.

10. The fixation structure of claim 1, further comprising:
a connection assembly cooperating with a connection hole at the bottom member and configured to be connected to an arm of the gimbal.

11. The fixation structure of claim 10, wherein:
the load includes a camera; and
a central axis of the connection hole is perpendicular to an optical axis of the camera.

12. The fixation structure of claim 1, wherein:
the hot shoe plate includes an upper surface and a lower surface located at two sides of the hot shoe plate opposite to each other, the sliding member including a sliding slot extending from the upper surface to the lower surface; and
the fixation assembly includes:
an adjustment knob arranged at the upper surface;
an adjustment threaded rod fixedly connected to the adjustment knob, passing through the sliding slot, and including a rod body and a block member, the block member being located at an end of the rod body away from the adjustment knob;
an upper fixation block arranged at a side where the lower surface is located; and
a lower fixation block arranged at the side where the lower surface is located, the lower fixation block being arranged in the upper fixation block, the adjustment threaded rod passing through the upper fixation block to be screwed with the lower fixation block, and the block member being configured to block the lower fixation block;
wherein the adjustment knob is configured to rotate to drive the adjustment threaded rod to rotate to cause the lower fixation block to move along the rod body.

13. The fixation structure of claim 12, wherein the fixation assembly further includes:
a fixation gasket sleeved at the adjustment threaded rod and clamped between the adjustment knob and the upper surface.

14. The fixation structure of claim 12, wherein:
the adjustment knob includes:
a top surface;
a bottom surface facing the upper surface, a recess being arranged at the bottom surface, and an end of the rod body away from the blocking member being accommodated in the recess; and
a side surface connecting the top surface and the bottom surface, a side hole connecting the recess being arranged at the side surface; and
the fixation assembly further includes:
a fastening part passing through the side hole and fixedly connected to the rod body.

15. The fixation structure of claim 12, wherein the fixation assembly further includes:
a fixation elastic member, an end of the fixation elastic member being coupled to the upper fixation block, and another end of the fixation elastic member being coupled to the lower fixation block.

16. The fixation structure of claim 15, wherein the fixation elastic member is one of a plurality of fixation elastic members of the fixation assembly that are distributed evenly around the adjustment threaded rod.

17. The fixation structure of claim 15, wherein the lower fixation block includes:
a body; and
protrusions extending from two sides of the body and cooperating with a hot shoe groove of the load to fix the load.

18. The fixation structure of claim 17, wherein:
the upper fixation block includes an upper recess;
the body is accommodated in the upper recess;
the body includes:
a first surface located in the upper recess; and
a second surface opposite to the first surface, the first surface being recessed toward the second surface to form an accommodation groove;
the fixation elastic member is accommodated in the accommodation groove; and
an end of the fixation elastic member is coupled to a bottom wall of the upper recess, and another end of the fixation elastic member is coupled to a bottom wall of the accommodation groove.

19. The fixation structure of claim 12, wherein:
a cold shoe groove is formed at the upper surface and located between the first end and the second end.

20. A gimbal system comprising:
a gimbal;
a load; and
a fixation structure configured to be connected to the load at the gimbal and including:
a hot shoe plate including:
a connection member arranged at a first end of the hot shoe plate; and
a sliding member arranged at a second end of the hot shoe plate that is opposite to the first end;
a hot shoe rod assembly including a fixation rod detachably mounted at the connection member, the fixation rod including a top member and a bottom member opposite to each other, and the bottom member being configured to be connected to the gimbal;
a locking assembly configured to fix the hot shoe rod assembly at the hot shoe plate; and
a fixation assembly configured to cooperate with the sliding member to connect the load at any position of the sliding member.
